(19) United States
(12) Patent Application Publication
(10) Pub. No.: US 2025/0303963 A1
(43) Pub. Date: Oct. 2, 2025

(54) VEHICULAR INTERIOR REARVIEW MIRROR ASSEMBLY WITH FULL MIRROR VIDEO DISPLAY

(71) Applicant: Magna Mirrors of America, Inc., Holland, MI (US)

(72) Inventor: Mark L. Larson, Grand Haven, MI (US)

(21) Appl. No.: 19/089,250

(22) Filed: Mar. 25, 2025

Related U.S. Application Data
(60) Provisional application No. 63/569,881, filed on Mar. 26, 2024.

(51) Int. Cl. B60R 1/12; B60R 1/04; B60R 1/08; B60R 11/00

(52) U.S. Cl. CPC B60R 1/12; B60R 1/04; B60R 1/088; B60R 11/00; B60R 2001/1215; B60R 2011/0033

(57) ABSTRACT

A vehicular interior rearview mirror assembly includes a mirror head that is adjustable relative to a mounting base and that includes a mirror head that accommodates a mirror reflective element and a video display screen disposed behind the mirror reflective element. The mirror assembly is operable in a mirror state where the display screen is not operated and the mirror reflective element provides a rearward view for the driver and is operable in a display state where the display screen is operated to display video images viewable through the mirror reflective element. The display screen includes a liquid crystal display (LCD) and a backlight assembly that includes a reflector and a light guide. In the display state, the reflector reflects light incident at the backlight assembly and the light guide guides the reflected light toward the LCD to at least partially backlight the LCD.

### CROSS REFERENCE TO RELATED APPLICATION

The present application claims the filing benefits of U.S. provisional application Ser. No. 63/569,881, filed Mar. 26, 2024, which is hereby incorporated herein by reference in its entirety.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a double ball pivot or joint mounting configuration where the mirror head and reflective element are adjusted relative to the interior portion of a vehicle by pivotal movement about the double ball pivot configuration. The mirror head and reflective element are pivotable about either or both of the ball pivot joints by a user that is adjusting a rearward field of view of the reflective element.

### SUMMARY OF THE INVENTION

A vehicular interior rearview mirror assembly includes a mirror head adjustable relative to a mounting base. The mounting base is configured to attach at an interior portion of a cabin of a vehicle. The mirror head accommodates a mirror reflective element and a video display screen. With the mounting base attached at the interior portion of the cabin of the vehicle, the mirror head is adjustable by a driver of the vehicle to set a rearward view for the driver and the video display screen is electrically operable to display video images for viewing by the driver. The video display screen is disposed within the mirror head and behind the mirror reflective element such that displayed video images are viewable through the mirror reflective element. With the mounting base attached at the interior portion of the cabin of the vehicle, the vehicular interior rearview mirror assembly (i) is operable in a mirror state, where the video display screen is not electrically operated and the mirror reflective element provides the rearward view for the driver, and (ii) is operable in a display state, where the video display screen is electrically operated to display video images for viewing by the driver through the mirror reflective element. The video display screen includes a liquid crystal display (LCD) video display screen and a backlight assembly. When the vehicular interior rearview mirror assembly is operated in the display state, the backlight assembly emits light to backlight or illuminate the LCD video display screen and display video images. The backlight assembly includes a reflector that reflects light incident at the backlight assembly and a light guide that directs or guides the reflected light toward the LCD video display screen to at least partially backlight the LCD video display screen and display video images. Thus, the LCD video display screen may be naturally backlit when displaying video images and the LCD video display screen and light guide may provide a structural component of the mirror head. In some examples, the mirror assembly may also accommodate electrically operable light sources, such as one or more light emitting diodes (LEDs) that emit light toward the light guide to supplement the ambient light backlighting. That is, the video display screen may be backlight by ambient light incident at the mirror reflective element and/or electrically operable light sources disposed behind and/or adjacent the light guide.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicular interior rearview mirror assembly;

FIGS. 2-10 are sectional views of the interior rearview mirror assembly, showing a video display screen and a backlight assembly of the interior rearview mirror assembly;

FIG. 11 is a plan view of the interior rearview mirror assembly, showing a portion of the mirror reflective element at which video images displayed by the video display screen are viewable through the mirror reflective element; and

FIG. 12 is a plan view of the interior rearview mirror assembly, with the mirror reflective element and the video display screen removed from the mirror casing.

### DESCRIPTION OF THE PREFERRED EMBODIMENTS

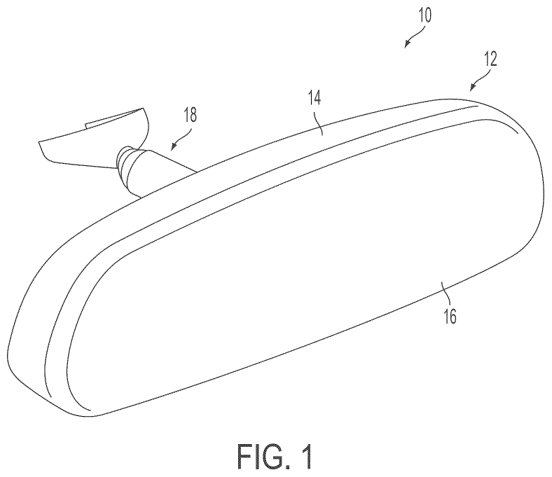

Referring now to the drawings and the illustrative embodiments depicted therein, a vehicular interior rearview mirror assembly 10 includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element includes a variable reflectance mirror reflective element that varies its reflectance responsive to electrical current applied to conductive coatings or layers of the reflective element.

The interior rearview mirror assembly may be used as a reflecting mirror assembly, and can also be changed to a video monitor, such as through use of a transflective surface and a high intensity display transposed behind the transflective surface. In other words, the mirror is provided with a video display screen that is disposed behind the mirror reflective element and that is operable to display images that are viewable through the mirror reflective element. Such video mirrors include a backlit liquid crystal display (LCD) display screen, and a particular form of video mirror is a full display mirror (such as a ClearView™ Interior Rearview Mirror Assembly available from Magna Mirrors of America, Inc. of Holland, MI USA, or an FDM™ Interior Rearview Mirror Assembly available from Gentex Corporation of Zeeland, MI USA), where the video images displayed at the video display screen fill or substantially fill the reflective region (e.g., fills or encompasses at least about 75 percent of the reflective region, or at least about 85 percent of the reflective region, or at least about 95 percent of the reflective region), such as by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2024-0383405; US-2021-0162926; US-2019-0258131; US-2019-0146297; US-2019-0118717 and/or US-2017-0355312, which are all hereby incorporated herein by reference in their entireties.

The mirror assembly may comprise a frameless mirror assembly, where a front glass substrate of the mirror reflective element may have an exposed rounded perimeter glass edge that provides a curved transition from the planar first surface of the front glass substrate to an outer less curved surface of the mirror casing (such as by utilizing aspects of the mirror assemblies described in U.S. Pat. Nos. 9,827,913; 9,174,578; 8,508,831; 8,730,553; 9,598,016 and/or 9,346,403, which are hereby incorporated herein by reference in their entireties). Optionally, the mirror assembly may include a casing portion that circumscribes the perimeter glass edge of the front glass substrate and provides the curved transition from the planar first surface of the front glass substrate to an outer less curved surface of the mirror casing, with the mirror casing portion not encroaching onto or overlapping the planar front or first surface of the front glass substrate (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties).

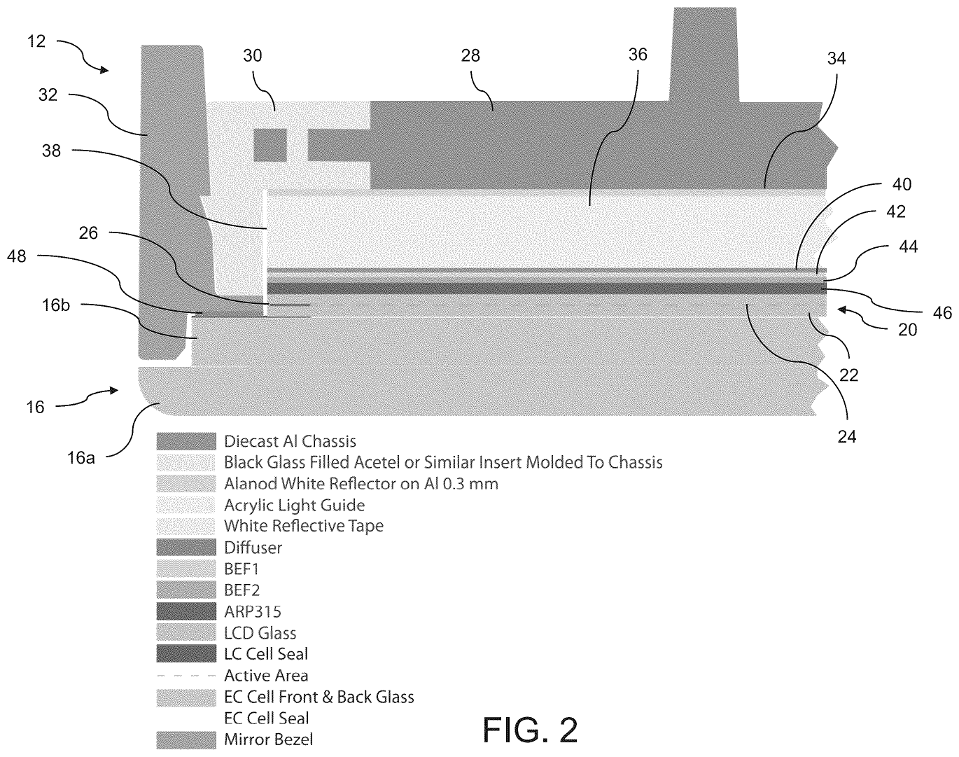

The mirror assembly 10 includes a video display screen 20 accommodated within the mirror head 12 and behind the mirror reflective element 16 so as to display video images that are viewable through the mirror reflective element 16 when the video display screen 20 is electrically operated to display video images (FIG. 2). The video display screen 20 may comprise an LCD display screen, such as a thin-film-transistor (TFT) LCD display, including an LCD glass panel 22 and that defines an active area 24 (i.e., a display area at which video images are viewable) that spans the LCD glass panel 22 and is bounded by a liquid crystal cell seal 26 disposed about a periphery region of the LCD glass panel 22. The display screen 20 further includes a backlight assembly and/or a plurality of layers of diffuser films, brightness enhancement films (BEFs), and/or reflectors behind the LCD glass panel 22 and configured to emit and/or direct light toward the LCD glass panel 22 for backlighting or illuminating the active area 24 and allowing the video display screen 20 to display video images.

The backlight assembly backlights the LCD glass panel 22 as the LCD glass panel 22 is electrically charged to display the video images. That is, the backlight assembly may provide a uniform distribution of light across the active area 24 for illuminating the video images displayed at the LCD glass panel 22. As discussed further below, the LCD video display may be naturally lit, with the light guide of the backlight assembly providing structural support to the mirror head. In other words, the backlight assembly may direct ambient light toward the LCD glass panel 22 to display or illuminate the video images. In some examples, an electrically operable light source within the mirror head may emit light that is directed toward the LCD glass panel, such as to provide supplementary lighting or illumination and a more even distribution of light than the ambient light source alone. Further, by utilizing the light guide as a structural member of the mirror head, the video display screen and backlight provides excellent structural stability, minimized video-to-edge-of-mirror dead space, is low cost, easy to assemble, and offers improved options for assembling the TFT display.

Because the mirror reflective element 16 of the frameless mirror assembly has a peripheral edge region that extends over and along an edge region of the mirror casing 14, the active area 24 may not extend or span the entire outer surface area of the mirror reflective element 16 that is viewable by the driver of the vehicle, causing an outer peripheral edge region of the mirror reflective element 16 to appear without video images. To reduce or eliminate the portion of the mirror reflective element 16 without video images (i.e., to increase the size of the active area 24), without compromising the structural integrity of the mirror assembly, the display screen and backlight assembly provides a structural feature of the mirror assembly. For example, a light guide may provide greater structural support than an array of light emitting diodes (LEDs) or other traditional backlight sources, and the display screen and backlight may be attached to portions of the mirror back plate and/or mirror casing to provide added structural stability to the mirror assembly.

Referring to FIG. 2, a mirror back plate is configured to attach the mirror reflective element 16 at the mirror casing 14. The mirror back plate includes a metallic portion or chassis 28, such as a diecast aluminum chassis, and a polymeric or resin or insert-molded portion 30, such as a black glass filled acetel or black stainless steel fiber filled acetel, that is insert molded to the metallic chassis 28. The metallic chassis 28 may include a heat sink or heat dissipating element for drawing heat away from the video display screen 20. The insert-molded portion 30 of the mirror back plate may be configured to attachably receive a bezel element 32 that circumscribes the mirror reflective element 16 and that may provide a smooth transition between the edge of the mirror reflective element and the edge of the mirror casing 14.

The mirror reflective element 16 and/or the video display screen 20 may adhesively attach to a portion of the mirror bezel 32 and/or the back plate. In the illustrated example, a series of reflector films, a light guide, and diffusers are disposed between the mirror back plate and the video display screen 20 to direct and/or emit light toward and illuminate the LCD glass panel 22. That is, a reflector 34, such as a white reflector (e.g., having a thickness of about 0.3 millimeters) commercially available from ALANOD of Ennepetal, Germany, is disposed at the mirror back plate. A light guide 36, such as an acrylic light guide, is disposed at the reflector 34 and a reflective element 38, such as a white reflective tape, circumscribes the edge of the light guide 36 so that the reflector 34 and reflective element 38 reflect light and direct the reflected light into the light guide 36. The light guide 36 is configured to emit or direct light toward the video display screen 20, such as to provide a uniform distribution of illumination across the active area 24. Ambient light may pass through the mirror reflective element 16 and/or the video display screen 20 to be reflected by the light guide assembly for illuminating the video display screen 20. Accordingly, the backlight assembly may be configured to direct reflected natural light toward the LCD glass panel 22 for illuminating the LCD glass panel 22 to display images in a reflective LCD mode of operation for the mirror assembly.

One or more diffuser films and/or polarizers are disposed between the video display screen 20 and the light guide 36 to guide reflected light for illuminating the video display screen 20. For example, a diffuser film 40 is disposed at the light guide 36, and a first brightness enhancement film (BEF) 42 and a second BEF 44 are disposed between the diffuser film 40 and the video display screen 20. A polarizer 46, such as automotive reflective polarizer (ARP) 315 commercially available from 3M™ of St. Paul, MN, is disposed between the second BEF 44 and the video display screen 20.

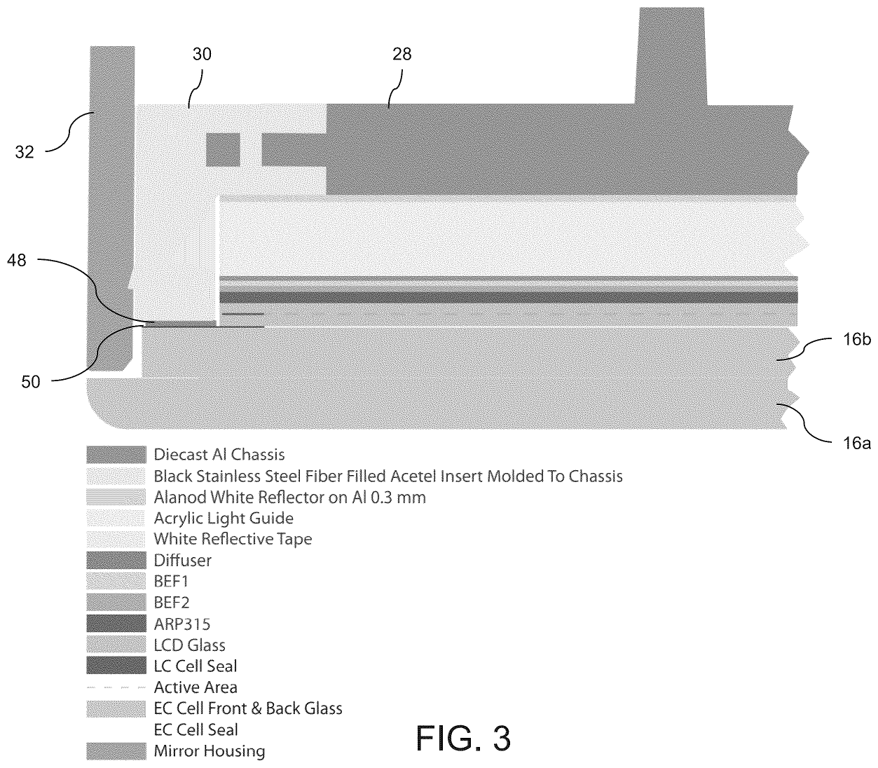

The mirror reflective element 16 comprises an electrochromic mirror reflective element having a front glass substrate 16a, a rear glass substrate 16b and an electrochromic medium disposed between the front glass substrate 16a and the rear glass substrate 16b. A peripheral edge region of the mirror reflective element 16 is adhesively attached at a portion of the mirror bezel 32 and electrical connection for electrically energizing the electrochromic medium is provided at a rear surface of the rear glass substrate 16b at the peripheral edge region. For example, a foam tape 48 or other suitable adhesive is disposed between the rear surface of the rear glass substrate 16b and the mirror bezel 32. The electrical connection, the EC cell seal between the front glass substrate 16a and the rear glass substrate 16b, and the LC cell seal 26 may substantially overlap so that an opaque hiding layer 50 (FIG. 3), such as a black epoxy mask printing, at the mirror reflective element 16 may render the connection and seals covert.

In some examples, and such as shown in FIG. 3, the mirror reflective element 16 attaches at the insert-molded portion 30 of the mirror back plate, such as via adhesive foam tape 48, and the mirror bezel 32 extends along a portion of the mirror reflective element 16 to provide the smooth transition between the edge of the mirror reflective element 16 and the mirror casing 14, and the mirror bezel 32 does not attach to the mirror reflective element 16. The mirror bezel 32 may be integrally formed with the mirror casing 14.

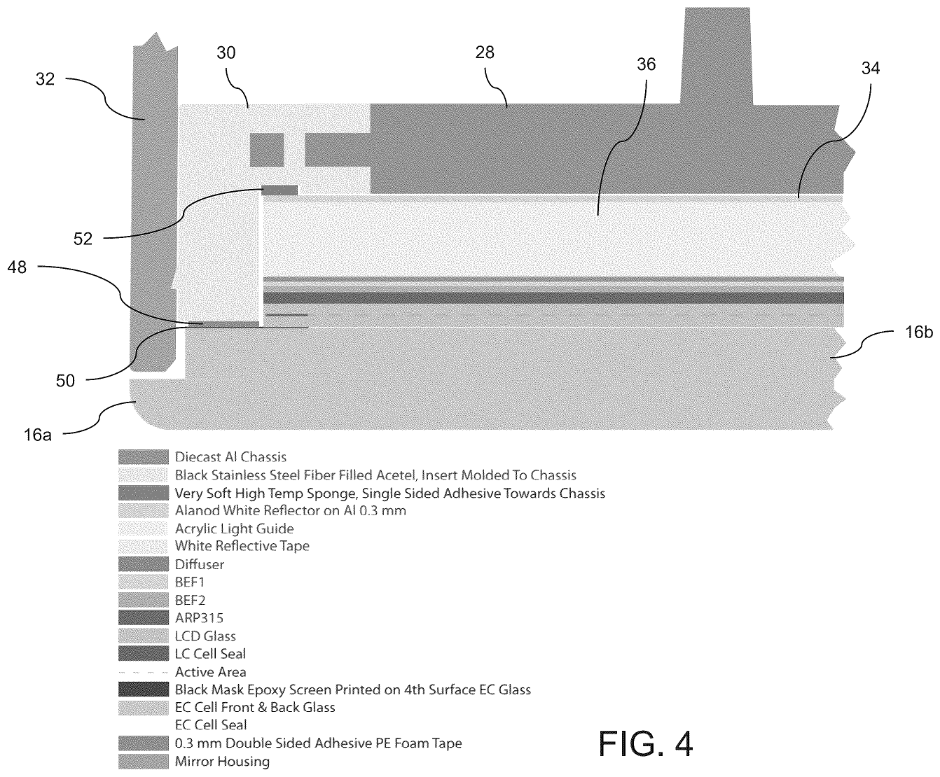

As shown in FIG. 4, the mirror reflective element 16 may be attached to the mirror back plate via adhesive foam tape 48 and a second adhesive element 52 may be disposed between the reflector 34, the light guide 36, and the insert-molded portion 30 of the mirror back plate. The second adhesive element 52 may comprise a single-sided adhesive that attaches to the mirror back plate and that includes a high temperature sponge or foam for engaging the reflector 34 and/or light guide 36. Thus, the second adhesive element 52 allows the reflector 34 and/or light guide 36 to move relative to the second adhesive element 52 and the mirror back plate. Optionally, the second adhesive element 52 maintains a gap or spacing between the rear surface of the light guide 36 and the mirror back plate.

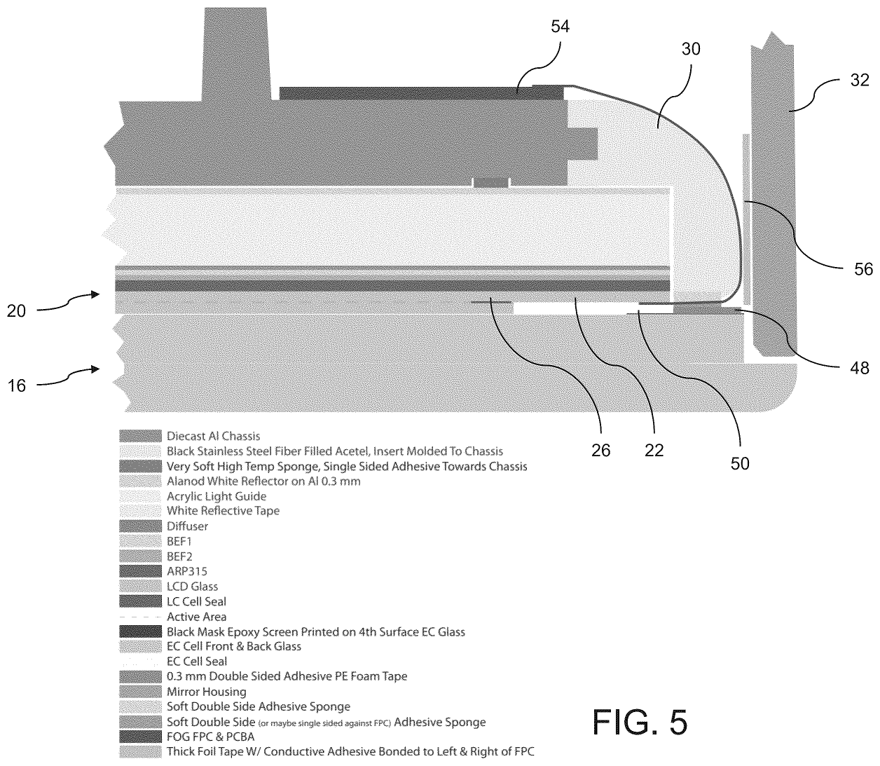

Referring to FIG. 5, the insert-molded portion 30 of the mirror back plate may have a curved or rounded edge region to allow an electrical connector 54 disposed at the rear surface of the back plate to extend along and around the mirror back plate for electrical connection to the video display screen 20. In the illustrated example, the electrical connector 54 includes a film on glass (FOG) flexible printed circuit (FPC) and a printed circuit board assembly (PCBA) and extends along an edge portion of the insert-molded portion 30 of the mirror back plate between the insert-molded portion 30 and the mirror bezel 32. A conductive element 56, such as a foil tape with conductive adhesive, is disposed at the interior surface of the mirror bezel 32 so that the FPC engages the conductive element 56 instead of the mirror bezel 32. The electrical connector 54 wraps around the insert-molded portion 30 of the mirror back plate and between the rear surface of the mirror reflective element 16 and the video display screen 20 to electrically connect to the video display screen 20, such as at a front surface of a rear substrate of the LCD glass 22. The electrical connector 54 may electrically connect to the video display screen 20 at a position outboard of the LC cell seal 26. That is, the rear substrate of the LCD glass 22 may extend beyond the LC cell seal 26 and beyond an edge of the front substrate of the LCD glass 22, with an end of the electrical connector 54 electrically connecting to the front surface of the rear substrate. An opposite end of the electrical connector 54 is disposed at the rear surface of the mirror back plate for electrically connecting to a wire harness of the vehicle.

Further, the electrical connector 54 may extend between the mirror reflective element 16 and the insert-molded portion 30 of the mirror back plate, such as between the adhesive foam tape 48 and one or more additional double sided adhesive sponges at the mirror back plate. The opaque hiding layer 50 may be disposed at the mirror reflective element 16 so as to overlap and hide the electrical connector 54, the adhesive foam tape 48 and additional adhesive sponge layers.

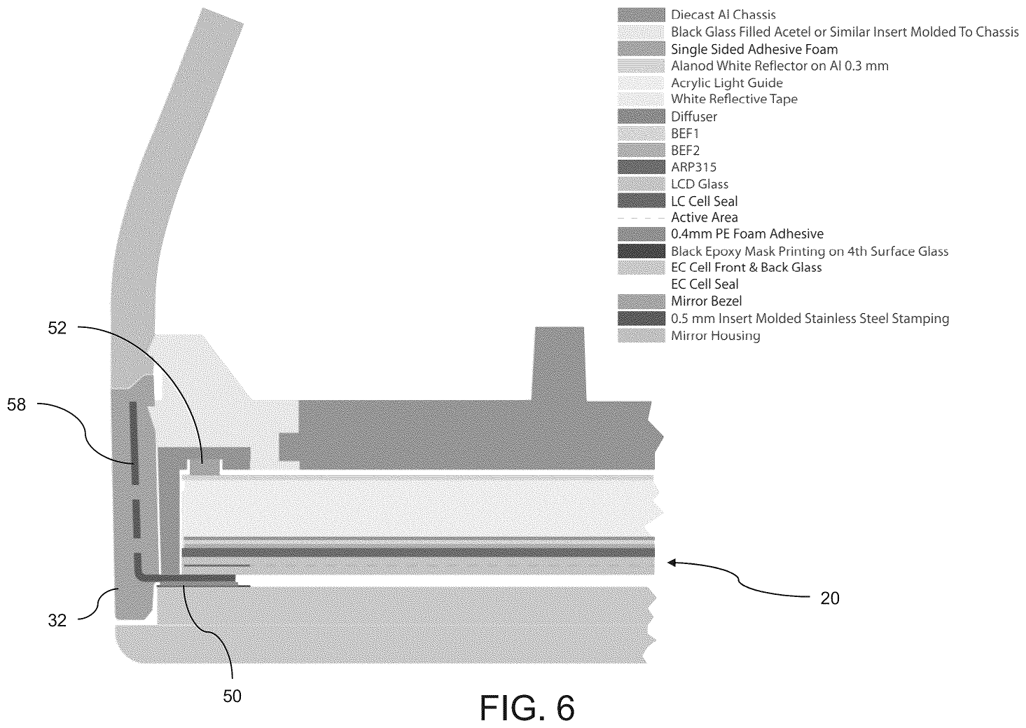

Optionally, electrical connection to the video display screen 20 may include an embedded or insert-molded electrical connector 58, such as a stainless steel stamping having a thickness of about 0.5 millimeters, that extends within at least a portion of the mirror bezel 32 (FIG. 6). An attaching end portion of the insert-molded electrical connector 58 may extend from the mirror bezel 32 and laterally inboard of the mirror bezel 32 between the rear surface of the mirror reflective element 16 and the front surface of the video display screen 20 for electrically connecting to the video display screen 20 and/or electrochromic mirror reflective element. The attaching end portion of the insert-molded electrical connector 58 may be aligned with the opaque hiding layer 50.

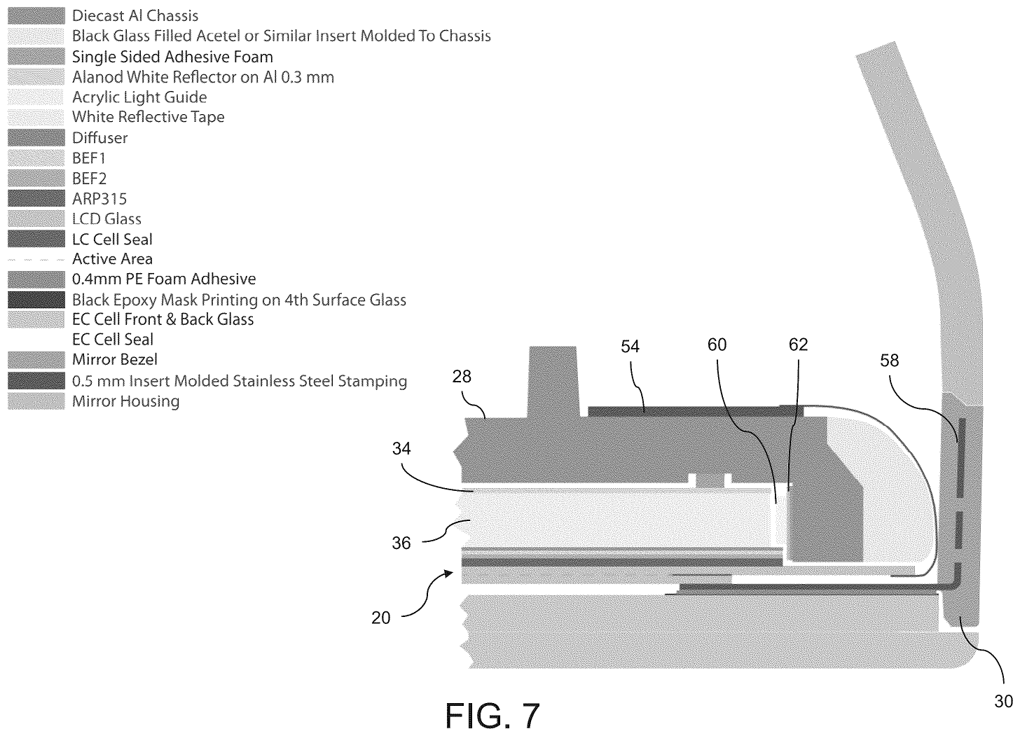

In some examples, the flexible electrical connector 54 at the rear surface of the mirror back plate may extend along the outer edge of the insert-molded portion 30 of the mirror back plate to electrically connect to the rear substrate of the LCD display 20 and the insert-molded electrical connector 58 may extend from the mirror bezel 32 to electrically connect to the front substrate of the LCD display 20 (FIG. 7).

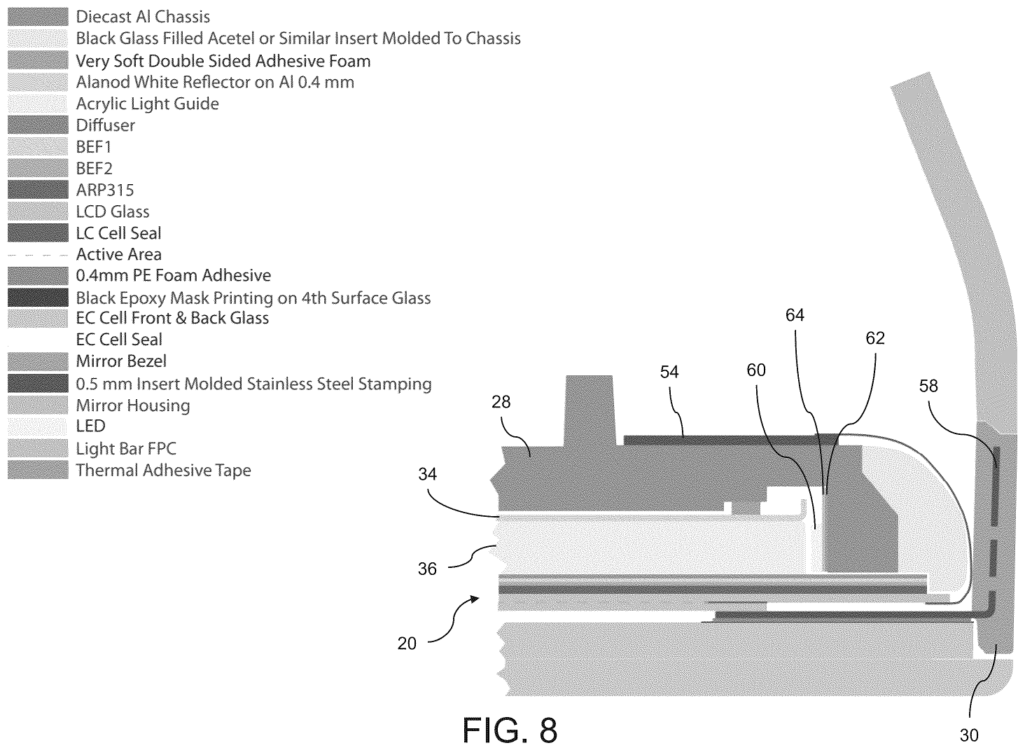

As shown in FIGS. 7 and 8, one or more light sources 60, such as LEDs or microLEDs or a light bar, are disposed adjacent and/or engaging the peripheral edge of the light guide 36. With the light guide 36 directing the light emitted by the peripheral LEDs 60 toward the LCD glass panel 22, the video display 20 may have electrically operable backlighting without sacrificing structural integrity of the mirror head. Thus, when the light sources 60 are operated, light is emitted toward the edge of the light guide 36 so that the light guide 36 and reflector 34 provide a uniform distribution of light across the active area 24 and direct the light toward the LCD glass panel 22 for illuminating the LCD display to show video images. Ambient light incident at the mirror reflective element 16 may also pass through the video display screen 20 to be reflected and directed by the backlight assembly back toward the video display screen 20 for illuminating the video images in a transflective mode of operation for the mirror assembly. The LEDs 60 may be attached at the metallic chassis 28 of the mirror back plate via a thermal adhesive tape 62 so that heat generated during operation of the LEDs 60 is dissipated through the metallic chassis 28. The one or more light sources 60 may be accommodated on a FPC 64 that attaches at the metallic chassis 28 via the thermal adhesive tape 62 (FIG. 8).

In some examples, LEDs for backlighting the video display screen 20 may be accommodated at the mirror backplate and behind the mirror reflective element 16 and light guide assembly. That is, the LEDs may be disposed at or near the rear surface of the light guide, such as at apertures formed through the reflector 34, for directing light that passes through the light guide and is directed toward the video display screen 20 for illuminating the video images. Use of peripheral reflector tape 38 and the reflector 34 at the rear surface of the light guide 36 may reduce the required number of light sources, and thus electrical and thermal load of the video display screen 20, as compared to traditional electrically operable backlight light sources.

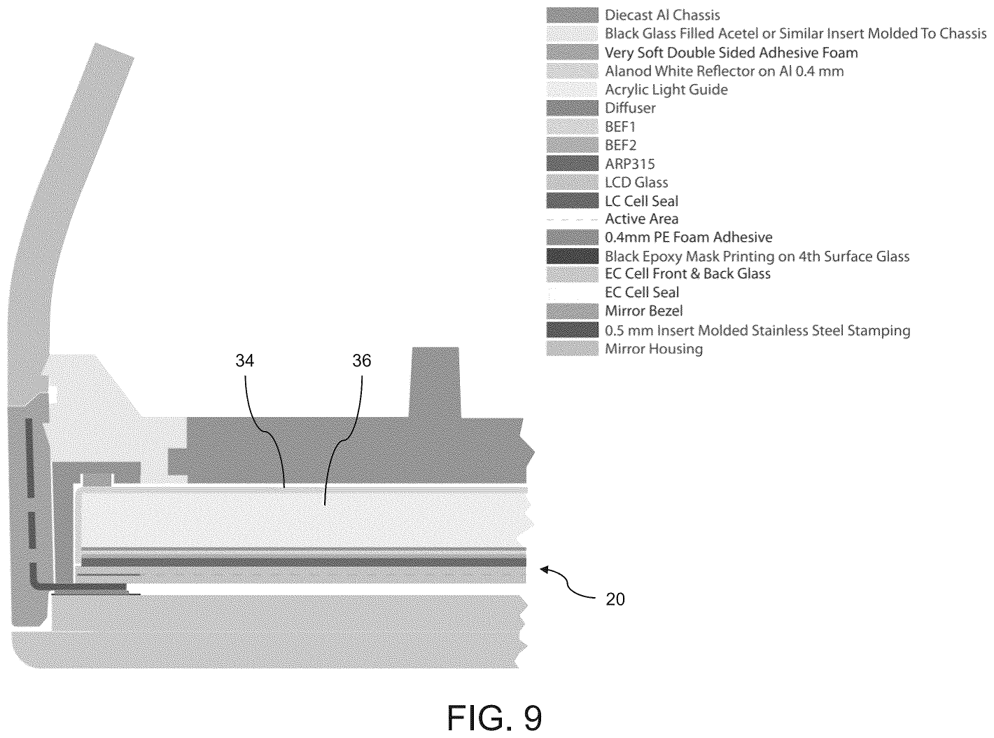

Optionally, and such as shown in FIG. 9, the reflector 34 may extend over and along the rear surface of the light guide 36 and the reflector 34 may extend over and along the peripheral edge regions of the light guide 36. That is, the reflector 34 may cover all but a front surface of the light guide 36 that faces the video display 20. Thus, a greater portion of light incident at the light guide 36 may be reflected by the reflector 34 and directed toward the video display 20. This may provide a brighter video display without increased use of electrically operated light sources.

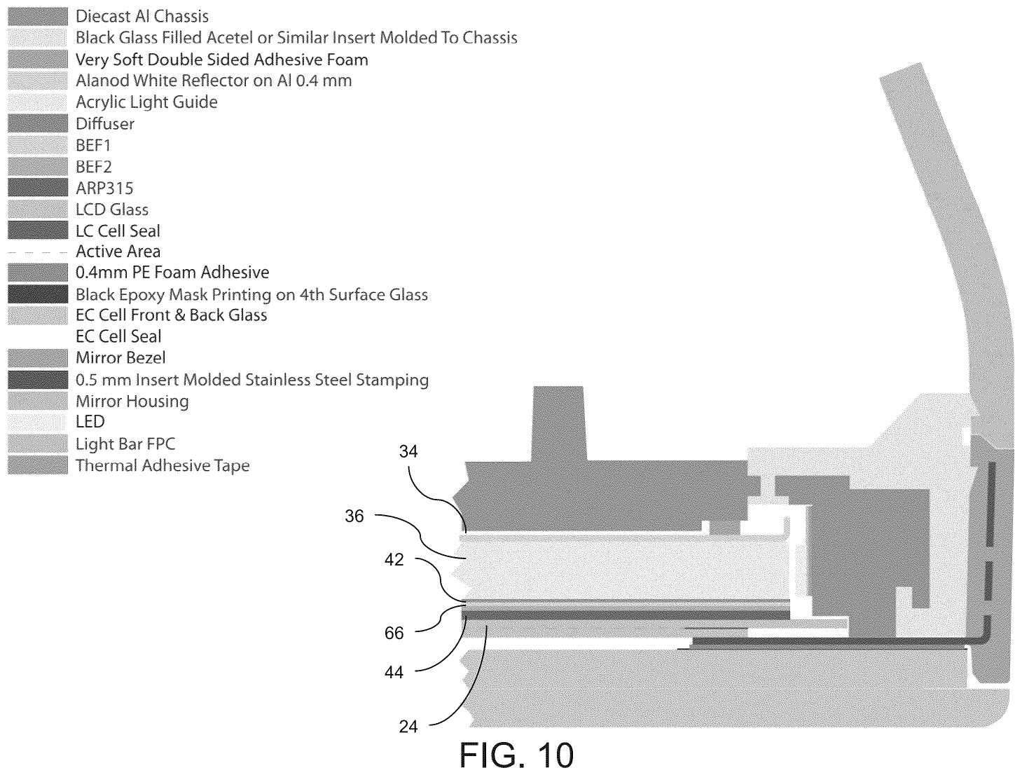

Further, and such as shown in FIG. 10, a display adhesive tape 66, such as a double sided adhesive foam may be disposed between the display 20 and the light guide 36, such as between the polarizer 46 and the second BEF 44. For example, the adhesive 66 may circumscribe the active area 24 to provide a clear boundary for video images displayed through the mirror reflective element 16.

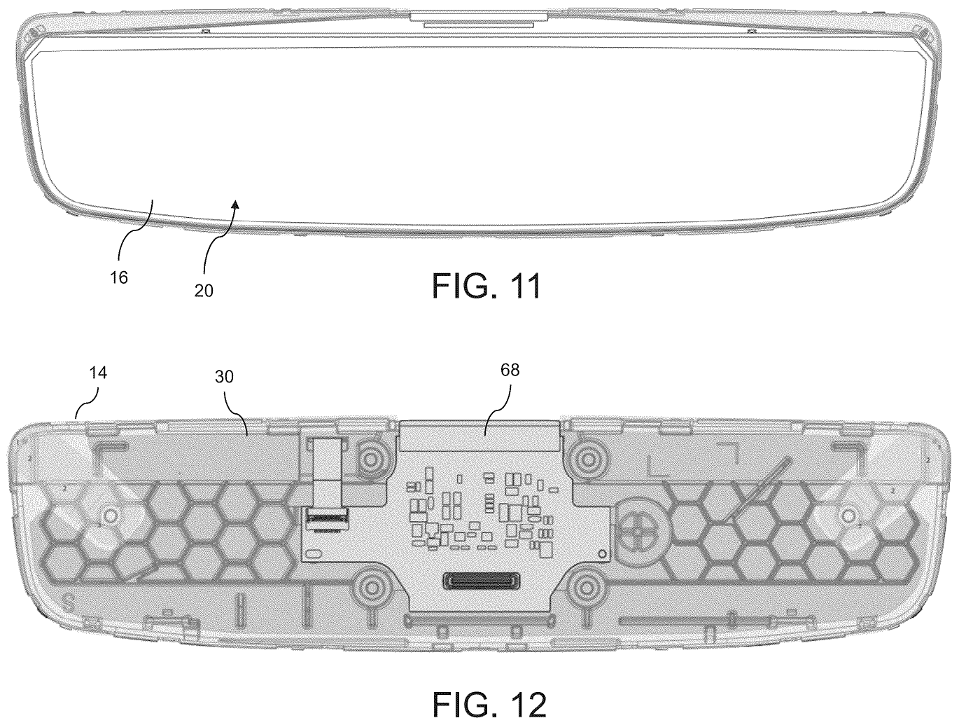

Thus, and as shown in FIGS. 11 and 12, the video display screen 20 may be operable to display video images that span a substantial portion of the mirror reflective element 16, such as 90 percent or more of the mirror reflective element 16 or 95 percent or more of the mirror reflective element 16. This may improve the likeness between displayed video images and traditional reflections viewable at the mirror reflective element, and thus improve perception for the driver viewing the mirror assembly. A PCB 68 may be accommodated within the mirror head 12 between the mirror casing 14 and the insert-molded portion 30 of the mirror back plate, with an aperture or cutout portion of the insert-molded portion 30 allowing for positioning of LEDs behind the light guide and/or electrical connection between the video display 20, the mirror reflective element 16, and/or the PCB 68.

The video display screen 20 of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected responsive to a user input, such as by flipping the mirror head of a prismatic mirror reflective element upward or downward (e.g., via a toggle located at the mirror head). When the mirror is operating in the mirror mode, the video display screen 20 is deactivated and rendered covert by the mirror reflective element 16, and the driver views rearward via reflection of light incident at the mirror reflective element 16. When the mirror is operating in the display mode, the video display screen 20 is operated to display video images that are viewable through the mirror reflective element 16 by the driver of the vehicle.

Further, when displaying video images, the LCD video display screen 20 of the mirror assembly may be operable in a reflective display mode, where the display screen 20 is illuminated via ambient light incident at the mirror reflective element and electrically operable light sources are not operated, and a transflective display mode, where the display screen 20 is illuminated via ambient light and electrically operable light sources are operated to emit light and at least partially backlight the video display screen. For example, the video display screen may be operated in the reflective display mode based on a determined level of ambient light at the mirror assembly being greater than a threshold level (e.g., during daytime operation of the video display screen) and the video display screen may be operated in the transflective display mode based on the determined level of ambient light being less than the threshold level (e.g., during nighttime operation of the video display screen).

The mirror casing may include a bezel portion that circumscribes a perimeter region of the front surface of the reflective element, or the perimeter region of the front surface of the reflective element may be exposed (such as by utilizing aspects of the mirror reflective elements described in U.S. Pat. Nos. 8,508,831 and/or 8,730,553, and/or U.S. Publication Nos. US-2014-0022390; US-2014-0293169 and/or US-2015-0097955, which are hereby incorporated herein by reference in their entireties).

The back plate may comprise any suitable construction. Optionally, for example, a common or universal backplate, whereby the appropriate or selected socket element or pivot element (such as a socket element or such as a ball element or the like) is attached to the backplate to provide the desired pivot joint for the particular mirror head in which the backplate is incorporated. Optionally, when molding the backplate, a different insert may be provided to integrally mold a portion of or all of a ball member or the like (such as a portion of a base of a ball member, whereby the ball member may comprise a metallic ball member that is insert molded at the base and at the rear of the backplate during the injection molding process that forms the backplate, such as by utilizing aspects of the mirror assemblies described in U.S. Pat. Nos. 7,855,755; 7,249,860 and 6,329,925 and/or U.S. Pat. Pub. No. US-2006-0061008, which are hereby incorporated herein by reference in their entireties).

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

Optionally, the reflective element may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066, 112; 7,626,749; 7,274,501; 7,184,190; 7,255,451; 8,508,831 and/or 8,730,553, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184, 190 and/or 7,255,451, which are hereby incorporated herein by reference in their entireties). Optionally, other opaque or substantially opaque coatings or bands may be implemented.

The video display screen may be controlled or operable in response to an input or signal, such as a signal received from one or more cameras or image sensors of the vehicle, such as a video camera or sensor, such as a CMOS imaging array sensor, a CCD sensor or the like, and image processors or image processing techniques, such as utilizing aspects of the cameras and image processors described U.S. Pat. Nos. 5,550,677; 5,670,935; 5,760,962; 6,498,620; 6,396,397; 6,222,447; 6,201,642; 6,097,023; 5,877,897; 5,796,094; 5,715,093; 6,922,292; 6,757,109; 6,717,610; 6,590,719; 6,320,176; 6,559,435; 6,831,261; 6,806,452; 6,822,563; 6,946,978; 7,038,577; 7,004,606 and/or 7,720,580, and/or U.S. Pat. Pub. Nos. US-2006-0171704; US-2009-0244361 and/or US-2010-0214791, and/or International Publication Nos. WO 2009/046268 and/or WO 2009/036176, which are all hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle. It is envisioned that an image processor or controller (such as an EYEQ™ image processing chip available from Mobileye Vision Technologies Ltd. of Jerusalem, Israel, and such as an image processor of the types described in U.S. Pat. No. 9,126,525, which is hereby incorporated herein by reference in its entirety) may process image data captured by the rearward facing camera to assess glare lighting conditions (such as to detect headlights of following vehicles that may cause glare at the interior and/or exterior rearview mirror assemblies of the equipped vehicle), and the controller may adjust or control the dimming of the electro-optic mirror assembly or assemblies of the equipped vehicle responsive to such image processing.

Changes and modifications in the specifically described embodiments may be carried out without departing from the principles of the present invention, which is intended to be limited only by the scope of the appended claims as interpreted according to the principles of patent law.

1. A vehicular interior rearview mirror assembly, the vehicular interior rearview mirror assembly comprising:
a mirror head adjustable relative to a mounting base, wherein the mounting base is configured to mount the vehicular interior rearview mirror assembly at an interior portion of an interior cabin of a vehicle;
wherein the mirror head accommodates a mirror reflective element and a video display screen;
wherein, with the vehicular interior rearview mirror assembly mounted at the interior portion of the interior cabin of the vehicle, the mirror head is adjustable by a driver of the vehicle to set a rearward view for the driver;
wherein, with the vehicular interior rearview mirror assembly mounted at the interior portion of the interior cabin of the vehicle, the video display screen is electrically operable to display video images for viewing by the driver;
wherein the video display screen is disposed within the mirror head and behind the mirror reflective element, and wherein, with the vehicular interior rearview mirror assembly mounted at the interior portion of the interior cabin of the vehicle, video images displayed at the video display screen are viewable by the driver through the mirror reflective element;
wherein, with the vehicular interior rearview mirror assembly mounted at the interior portion of the interior cabin of the vehicle, the vehicular interior rearview mirror assembly (i) is operable in a mirror state where the video display screen is not electrically operated and the mirror reflective element provides the rearward view for the driver and (ii) is operable in a display state where the video display screen is electrically operated to display video images for viewing by the driver through the mirror reflective element;
wherein the video display screen comprises a liquid crystal display (LCD) video display screen and a backlight assembly disposed within the mirror head and behind the video display screen, and wherein, when the vehicular interior rearview mirror assembly is operated in the display state, the backlight assembly emits light to backlight the LCD video display screen and display video images for viewing by the driver through the mirror reflective element; and
wherein the backlight assembly comprises (i) a reflector that reflects light incident at the backlight assembly and (ii) a light guide that guides the reflected light toward the LCD video display screen to at least partially backlight the LCD video display screen and display video images.

2. The vehicular interior rearview mirror assembly of claim 1, wherein the mirror reflective element is attached at a mirror back plate of the mirror head, and wherein the video display screen is disposed behind the mirror reflective element and between the mirror reflective element and the mirror back plate.

3. The vehicular interior rearview mirror assembly of claim 2, wherein the mirror back plate is accommodated by a mirror casing of the mirror head.

4. The vehicular interior rearview mirror assembly of claim 3, wherein, with the vehicular interior rearview mirror assembly mounted at the interior portion of the interior cabin of the vehicle, an electrical connector extends along a peripheral edge region of the mirror back plate between the mirror back plate and the mirror casing to electrically connect the LCD video display screen to a power source of the vehicle.

5. The vehicular interior rearview mirror assembly of claim 3, wherein, with the vehicular interior rearview mirror assembly mounted at the interior portion of the interior cabin of the vehicle, an electrical connector electrically connects the LCD video display screen to a power source of the vehicle, and wherein the electrical connector is insert molded with the mirror casing of the mirror head.

6. The vehicular interior rearview mirror assembly of claim 3, wherein the mirror back plate is snap attached at the mirror casing of the mirror head.

7. The vehicular interior rearview mirror assembly of claim 1, wherein the reflector reflects ambient light incident at the backlight assembly and the light guide guides the reflected ambient light toward the LCD video display screen to at least partially backlight the LCD video display screen and display video images.

8. The vehicular interior rearview mirror assembly of claim 7, wherein the light guide has a front side and a rear side, and wherein the front side is closer to the video display screen than the rear side, and wherein the reflector is disposed at the rear side of the light guide.

9. The vehicular interior rearview mirror assembly of claim 8, wherein a side surface of the light guide extends between the front side of the light guide and the rear side of the light guide, and wherein a second reflector is disposed at the side surface of the light guide.

10. The vehicular interior rearview mirror assembly of claim 9, wherein an electrically operable light source is accommodated within the mirror head, and wherein the electrically operable light source, when the vehicular interior rearview mirror assembly is operated in the display state, emits light toward the side surface of the light guide, and wherein the light guide guides the reflected ambient light and the light emitted by the electrically operable light source toward the LCD video display screen to backlight the LCD video display screen and display video images.

11. The vehicular interior rearview mirror assembly of claim 10, wherein the electrically operable light source comprises at least one selected from the group consisting of (i) a light emitting diode (LED), (ii) a microLED and (iii) a light bar.

12. The vehicular interior rearview mirror assembly of claim 8, wherein the backlight assembly comprises (i) a diffuser between the front side of the light guide and the LCD video display screen, (ii) a brightness enhancement film (BEF) between the front side of the light guide and the LCD video display screen and (iii) a polarizer between the front side of the light guide and the LCD video display screen.

13. The vehicular interior rearview mirror assembly of claim 1, wherein, when the vehicular interior rearview mirror assembly is operated in the display state, the video images are viewable through at least a portion of the mirror reflective element, and wherein the portion spans at least 90 percent of the mirror reflective element.

14. The vehicular interior rearview mirror assembly of claim 1, wherein the mirror reflective element comprises an electrochromic mirror reflective element.

15. The vehicular interior rearview mirror assembly of claim 1, wherein an electrically operable light source is accommodated within the mirror head, and wherein, when the electrically operable light source is electrically operated to emit light, the light guide guides the emitted light toward the LCD video display screen to at least partially backlight the LCD video display screen and display the video images.

16. The vehicular interior rearview mirror assembly of claim 15, wherein, when the vehicular interior rearview mirror assembly is operated in the display state, the backlight assembly is adjustable between (i) a reflective display mode where the electrically operable light source is not electrically operated to emit light and the light guide guides reflected ambient light toward the LCD video display screen to backlight the LCD video display screen and display video images and (ii) a transflective display mode where the electrically operable light source is electrically operated to emit light and the light guide guides the emitted light and the reflected ambient light toward the LCD video display screen to backlight the LCD video display screen and display video images.

17. The vehicular interior rearview mirror assembly of claim 16, wherein the backlight assembly is adjusted from the reflective display mode to the transflective display mode responsive to determination that a level of ambient light present at the vehicular interior rearview mirror assembly is less than a threshold level of ambient light.

18. A vehicular interior rearview mirror assembly, the vehicular interior rearview mirror assembly comprising:
a mirror head adjustable relative to a mounting base, wherein the mounting base is configured to mount the vehicular interior rearview mirror assembly at an interior portion of an interior cabin of a vehicle;
wherein the mirror head accommodates a mirror reflective element and a video display screen;
wherein the mirror reflective element is attached at a mirror back plate of the mirror head, and wherein the video display screen is disposed behind the mirror reflective element and between the mirror reflective element and the mirror back plate;
wherein, with the vehicular interior rearview mirror assembly mounted at the interior portion of the interior cabin of the vehicle, the mirror head is adjustable by a driver of the vehicle to set a rearward view for the driver;
wherein, with the vehicular interior rearview mirror assembly mounted at the interior portion of the interior cabin of the vehicle, the video display screen is electrically operable to display video images for viewing by the driver;
wherein the video display screen is disposed within the mirror head and behind the mirror reflective element, and wherein, with the vehicular interior rearview mirror assembly mounted at the interior portion of the interior cabin of the vehicle, video images displayed at the video display screen are viewable by the driver through the mirror reflective element;
wherein, with the vehicular interior rearview mirror assembly mounted at the interior portion of the interior cabin of the vehicle, the vehicular interior rearview mirror assembly (i) is operable in a mirror state where the video display screen is not electrically operated and the mirror reflective element provides the rearward view for the driver and (ii) is operable in a display state where the video display screen is electrically operated to display video images for viewing by the driver through the mirror reflective element;
wherein the video display screen comprises a liquid crystal display (LCD) video display screen and a backlight assembly disposed within the mirror head and behind the video display screen, and wherein, when the vehicular interior rearview mirror assembly is operated in the display state, the backlight assembly emits light to backlight the LCD video display screen and display video images for viewing by the driver through the mirror reflective element;
wherein the backlight assembly comprises (i) a reflector that reflects light incident at the backlight assembly and (ii) a light guide that guides the reflected light toward the LCD video display screen to at least partially backlight the LCD video display screen and display video images;
wherein an electrically operable light source is accommodated within the mirror head, and wherein, when the electrically operable light source is electrically operated to emit light, the light guide guides the emitted light toward the LCD video display screen to at least partially backlight the LCD video display screen and display video images;
wherein the reflector reflects ambient light incident at the backlight assembly and the light guide guides the reflected ambient light toward the LCD video display screen to at least partially backlight the LCD video display screen and display video images; and
wherein, when the vehicular interior rearview mirror assembly is operated in the display state, the backlight assembly is adjustable between (i) a reflective display mode where the electrically operable light source is not electrically operated to emit light and the light guide guides reflected ambient light toward the LCD video display screen to backlight the LCD video display screen and display video images and (ii) a transflective display mode where the electrically operable light source is electrically operated to emit light and the light guide guides the emitted light and the reflected ambient light toward the LCD video display screen to backlight the LCD video display screen and display video images.

19. The vehicular interior rearview mirror assembly of claim 18, wherein the mirror back plate is accommodated by a mirror casing of the mirror head, and wherein, with the vehicular interior rearview mirror assembly mounted at the interior portion of the interior cabin of the vehicle, an electrical connector extends along a peripheral edge region of the mirror back plate between the mirror back plate and the mirror casing to electrically connect the LCD video display screen to a power source of the vehicle.

20. The vehicular interior rearview mirror assembly of claim 19, wherein, with the vehicular interior rearview mirror assembly mounted at the interior portion of the interior cabin of the vehicle, an electrical connector electrically connects the LCD video display screen to a power source of the vehicle, and wherein the electrical connector is insert molded with the mirror casing of the mirror head.

21. The vehicular interior rearview mirror assembly of claim 18, wherein the light guide has a front side and a rear side, and wherein the front side is closer to the video display screen than the rear side, and wherein the reflector is disposed at the rear side of the light guide.

22. The vehicular interior rearview mirror assembly of claim 18, wherein, when the vehicular interior rearview mirror assembly is operated in the display state, the video images are viewable through at least a portion of the mirror reflective element, and wherein the portion spans at least 90 percent of the mirror reflective element.

23. The vehicular interior rearview mirror assembly of claim 18, wherein the mirror reflective element comprises an electrochromic mirror reflective element.

24. The vehicular interior rearview mirror assembly of claim 18, wherein the backlight assembly is adjusted from the reflective display mode to the transflective display mode responsive to determination that a level of ambient light present at the vehicular interior rearview mirror assembly is less than a threshold level of ambient light.

25. A vehicular interior rearview mirror assembly, the vehicular interior rearview mirror assembly comprising:
a mirror head adjustable relative to a mounting base, wherein the mounting base is configured to mount the vehicular interior rearview mirror assembly at an interior portion of an interior cabin of a vehicle;
wherein the mirror head accommodates a mirror reflective element and a video display screen;
wherein, with the vehicular interior rearview mirror assembly mounted at the interior portion of the interior cabin of the vehicle, the mirror head is adjustable by a driver of the vehicle to set a rearward view for the driver;
wherein, with the vehicular interior rearview mirror assembly mounted at the interior portion of the interior cabin of the vehicle, the video display screen is electrically operable to display video images for viewing by the driver;
wherein the video display screen is disposed within the mirror head and behind the mirror reflective element, and wherein, with the vehicular interior rearview mirror assembly mounted at the interior portion of the interior cabin of the vehicle, video images displayed at the video display screen are viewable by the driver through the mirror reflective element;
wherein, with the vehicular interior rearview mirror assembly mounted at the interior portion of the interior cabin of the vehicle, the vehicular interior rearview mirror assembly (i) is operable in a mirror state where the video display screen is not electrically operated and the mirror reflective element provides the rearward view for the driver and (ii) is operable in a display state where the video display screen is electrically operated to display video images for viewing by the driver through the mirror reflective element;
wherein, when the vehicular interior rearview mirror assembly is operated in the display state, the video images are viewable through at least a portion of the mirror reflective element, and wherein the portion spans at least 90 percent of the mirror reflective element;
wherein the video display screen comprises a liquid crystal display (LCD) video display screen and a backlight assembly disposed within the mirror head and behind the video display screen, and wherein, when the vehicular interior rearview mirror assembly is operated in the display state, the backlight assembly emits light to backlight the LCD video display screen and display video images for viewing by the driver through the mirror reflective element;
wherein the backlight assembly comprises (i) a reflector that reflects light incident at the backlight assembly and (ii) a light guide that guides the reflected light toward the LCD video display screen to at least partially backlight the LCD video display screen and display video images;
wherein the light guide has a front side and a rear side, and wherein the front side is closer to the video display screen than the rear side, and wherein the reflector is disposed at the rear side of the light guide; and
wherein a side surface of the light guide extends between the front side of the light guide and the rear side of the light guide, and wherein a second reflector is disposed at the side surface of the light guide.

26. The vehicular interior rearview mirror assembly of claim 25, wherein the mirror reflective element comprises an electrochromic mirror reflective element.

27. The vehicular interior rearview mirror assembly of claim 25, wherein an electrically operable light source is accommodated within the mirror head, and wherein, when the electrically operable light source is electrically operated to emit light, the light guide guides the emitted light toward the LCD video display screen to at least partially backlight the LCD video display screen and display the video images.

28. The vehicular interior rearview mirror assembly of claim 27, wherein, when the vehicular interior rearview mirror assembly is operated in the display state, the backlight assembly is adjustable between (i) a reflective display mode where the electrically operable light source is not electrically operated to emit light and the light guide guides reflected ambient light toward the LCD video display screen to backlight the LCD video display screen and display video images and (ii) a transflective display mode where the electrically operable light source is electrically operated to emit light and the light guide guides the emitted light and the reflected ambient light toward the LCD video display screen to backlight the LCD video display screen and display video images.
